(19) United States
(12) Patent Application Publication
(10) Pub. No.: US 2026/0094317 A1
(43) Pub. Date: Apr. 2, 2026

(54) STANDARDIZING DISCRETIONARY DECISIONS IN GENERATIVE ARTIFICIAL INTELLIGENCE AUTHORING SYSTEMS

(71) Applicant: INTUIT INC., Mountain View, CA (US)

(72) Inventors: Ronnie Douglas DOUTHIT, Trinidad, TX (US); Deepankar MOHAPATRA, Plano, TX (US); Prabhavathi KARAVADI, Frisco, TX (US)

(21) Appl. No.: 18/901,637

(22) Filed: Sep. 30, 2024

(51) Int. Cl. G06T 11/00; G06F 8/35

(52) U.S. Cl. CPC G06T 11/10; G06F 8/35

(57) ABSTRACT

Aspects of the present disclosure relate to automatically generating artifacts. Embodiments include generating a first segment of an artifact based on providing a generative machine learning model with a first segment of an artifact template. Embodiments further include recording decisions made by the generative machine learning model in generating the first segment. Embodiments further include generating a second segment of the artifact based on providing the generative machine learning model with a second segment of the artifact template and the recorded decisions.

### INTRODUCTION

Aspects of the present disclosure relate to techniques for automatically generating artifacts. In particular, techniques described herein involve recording the decisions made by a generative machine learning model in generating segments of an artifact. The recorded decisions may be provided to the generative machine learning model during generation of subsequent segments such that the generative machine learning model will avoid making inconsistent decisions.

### BACKGROUND

Every year, a growing number of people, businesses, and organizations around the world use generative machine learning technologies to generate artifacts such as texts, images, and software code. These generative machine learning technologies can near-instantaneously perform tasks that would otherwise require an extensive amount of time and manual labor to complete.

However, generative machine learning technologies are not without limitations. Many artifacts must be generated in segments due to computational limitations of a generative machine learning model. For example, larger artifacts may exceed token or size limits of a machine learning model, and high usage rates may lead to smaller artifacts exceeding the capacity of a model as well.

Thus, there is a need in the art for improved techniques of automatically generating artifacts.

### BRIEF SUMMARY

Certain embodiments provide a method of automatically generating artifacts. The method generally includes: generating a first segment of an artifact based on providing a generative machine learning model with a first segment of an artifact template; recording decisions made by the generative machine learning model in generating the first segment; and generating a second segment of the artifact based on providing the generative machine learning model with a second segment of the artifact template and the recorded decisions.

Some embodiments provide a method of automatically generating artifacts. The method generally includes: generating a first segment of a software artifact based on providing a generative machine learning model with a first segment of a software artifact template; creating embedding representations of variable names within the first segment of the software artifact; and generating a second segment of the artifact based on the embedding representations and a second segment of the software artifact template.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of computing components related to automatically generating artifacts.

FIG. 2 depicts an example of a template segment and recorded decisions used to automatically generate artifacts.

FIG. 3 depicts example operations related to automatically generating artifacts.

FIG. 4 depicts additional example operations related to automatically generating artifacts.

FIG. 5 depicts an example of a processing system for automatically generating artifacts.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automatically generating artifacts.

According to certain embodiments, a generative machine learning model is used to generate an artifact. The generative machine learning model may generate the artifact segment-by-segment. However, breaking the generation of an artifact into segments creates a possibility for errors to occur. As an example, each time a machine learning model generates an artifact or a segment of an artifact, the model makes various discretionary decisions. These decisions may include, for example, names for a variable of a software artifact, color palettes for an image artifact, tone of a text artifact, and/or the like. If an artifact is generated as a single segment, the various aspects of the artifact will likely be consistent throughout. However, when the artifact is generated segment-by-segment, the generative model may make different decisions for each segment. Thus, different variable names may be used for the same variable throughout a generated software code base, resulting in extensive errors. Or, abrupt changes in tone may appear throughout a generated text, mismatched color palettes may be used throughout an image, and so on. Such inconsistencies may require manual intervention (e.g., by a user who manually corrects a defective artifact or identifies the defects and prompts the generative machine learning model to correct the defects), thus preventing the full automation of generating large artifacts that require segment-by-segment generation.

To address these challenges, according to aspects of the present disclosure, in generating a segment of an artifact, a generative machine learning model may also generate a list of decisions the generative machine learning model made while generating the segment. Alternatively, another computing component may record the decisions made by the generative machine learning model. For example, a computing component may record variable names used by the generative machine learning model (e.g., by parsing an artifact generated by the generative machine learning model). The recorded decisions may be provided to the generative machine learning model when a subsequent segment of the artifact is being generated. When provided with a set of one or more prior decisions, the generative machine learning model may avoid making decisions that contradict the prior decisions. In some embodiments, relevant decisions may be retrieved based on the segment of the artifact that is being generated (e.g., by storing embedding representations or other representations of decisions (e.g., associated with indications of artifacts and segments of those artifacts to which the decisions correspond) and searching through such representations based on the segment and/or artifact being generated).

Embodiments of the present disclosure provide numerous technical and practical effects and benefits. For example, techniques described herein prevent generative machine learning models from making inconsistent decisions when generating artifacts segment-by-segment. Avoiding such inconsistencies can prevent catastrophic errors from occurring in the generation of artifacts. As an example, if a software artifact (e.g., source code for a software application) is particularly large, segment-by-segment generation may be required. If the generative machine learning model uses a different name in a second segment for a variable that was already used and named in the first segment, the software artifact may fail to compile or function properly. However, when provided with a set of prior decisions using techniques described herein, the generative machine learning model may make consistent decisions for all sections of the artifact. By preventing generative machine learning models from making inconsistent decisions, techniques disclosed herein enable the full automation of generating large segments that require segment-by-segment generation (e.g., by removing the need for manual intervention), which was not possible with existing generative techniques.

### Example of Computing Components Related to Automatically Generating Artifacts

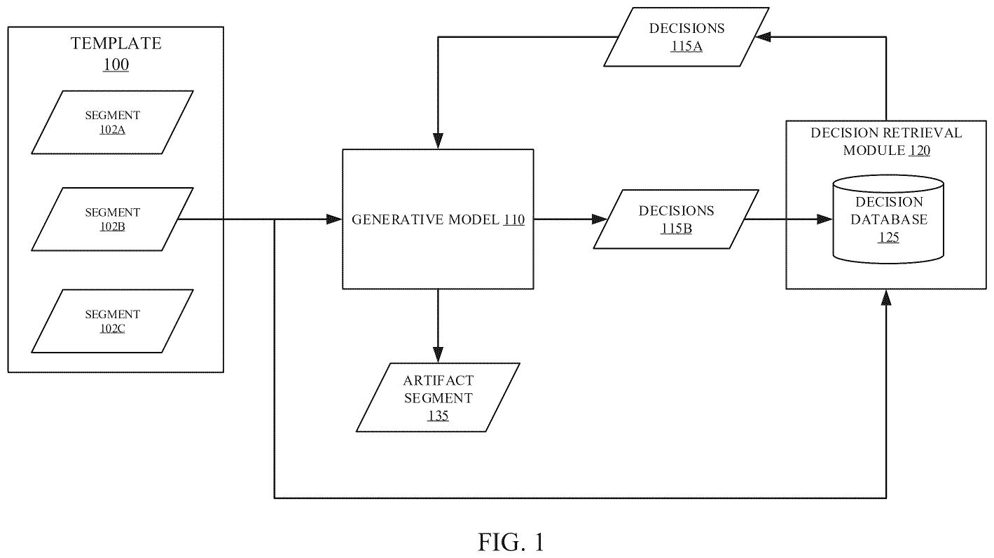

FIG. 1 depicts an example of computing components related to automatically generating artifacts.

A template 100 of an artifact may be used to generate an artifact. The template 100 may be a generic version of the artifact. A generative model 110 may use the template to create the artifact based on other input from a user (e.g., the artifact may be a populated and/or otherwise modified version of the template 100 that is customized to achieve a goal indicated by the user input). For example, a user may want to use the generative model 110 to create source code for a software application that performs a given task. The generative model 110 may generally be any type of generative machine learning model, such as a large language model (LLM). The generative model 110 may be provided a template 100 of source code for a software application, and the generative model 110 may update the template 100, populate the template 100, and/or the like to create source code that performs the given task. In other embodiments, the template 100 may be a template for another type of artifact besides a software artifact, such as an image or a text artifact.

Artifacts may be generated in segments. Segment-by-segment generation may, for example, prevent exceeding the capacity (e.g., a token limit or resource usage limit) of the generative model 110. To generate an artifact segment-by-segment, segments 102 of the template 100 may be provided to the generative model 110 one at a time. In the example embodiment shown in FIG. 1, the template 100 is divided into segments 102A, 102B, and 102C. The sizes of these segments 102 may be chosen based on the size of the template 100 and the capacity of the generative model 110. For example, a machine learning model may be trained to select segment sizes based on historical usage data associated with the generative model 110 (e.g., the usage data may indicate sizes of artifact segments, times at which the segments were generated, levels of resource (e.g., processing and/or memory resource) usage associated with the generative model 110 when a segment was generated, and/or whether generation failed or succeeded). The trained machine learning model may select a size for a segment (e.g., based on an input time or a current level of resource usage for the generative model 110), and a segment of the selected size may be chosen. Alternatively, segment sizes may be selected based on rules, such as rules that associate particular segment sizes with factors such as the size of the template 100, the input capacity and/or resource utilization capacity of the generative model 110, input time, a current level of resource usage for the generative model 110, and/or the like.

In the example embodiment shown in FIG. 1, segment 102B of the template 100 is provided to the generative model 110 so that the generative model 110 will generate the second segment of the artifact. Decisions 115A, which may represent one or more decisions that the generative model 110 made in generating the first segment of the artifact, may be provided to the generative model 115A. In embodiments where the artifact is a software artifact, the decisions 115 may comprise names chosen for variables, functions chosen to perform specific tasks, and/or any other discretionary decision that the generative model 110 may make in generating a software artifact. In embodiments where the decisions 115 include choices for variable names, the decisions 115 may comprise a list of variable names chosen by the generative model 110. For example, the template 100 may contain the variable “parameterName.” The generative model 110 may have generated an artifact segment where the name “parName” was chosen for this variable. This decision may be recorded and provided to the generative model 110 when the generative model 110 generates subsequent segments. The recording of the decision may comprise the chosen name (e.g., “parName”). In some embodiments, the recording of the decision may comprise a description of the decision, such as “‘parName’ was chosen as the name for variable ‘parameterName.’” This is included as an example of how a decision may be recorded, and other formats for recording decisions are possible.

In embodiments where the artifact to be generated is an image, the decisions 115 may relate to the color palette, theme, or any other discretionary decision regarding the image. In embodiments where the artifact to be generated is text, the decisions 115 may relate to the tone, sophistication, or other discretionary decisions regarding the text.

Certain embodiments provide that the decisions are recorded by the generative model 110. For example, the generative model 110 may be configured to output and/or record the decisions in connection with generating a segment, such as by providing the generative model 110 with a prompt instructing it to output the decisions (e.g., in a particular format, such as before or after the generated segment) or otherwise to record the decisions. In some embodiments, decisions may be extracted and/or recorded by a computing component separate from the generative model 110. For example, a generated artifact segment may be provided to a data parser that is configured to extract features such as variable names, and the parser may record the features. Recorded decisions may be stored in decision database 125

In some embodiments, embedding representations of decisions, templates, and/or segments are created. For example, embedding representations of chosen variable names and/or variables for which names were chosen may be created and stored in decision database 125. In another example, embedding representations of artifacts, artifact templates, artifact types, and/or segments of those artifacts, artifact templates, and/or artifact types may be created and stored in decision database 125, such as in connection with indications of corresponding decisions for particular artifacts, artifact templates, artifact types, and/or segments of those artifacts, artifact templates, and/or artifact types. An embedding generally refers to a vector representation of an entity that represents the entity as a vector in n-dimensional space such that similar entities are represented by vectors that are close to one another in the n-dimensional space. Embeddings may be generated through the use of an embedding model, such as a neural network or other type of machine learning model that learns a representation (embedding) for an entity through a training process that trains the neural network based on a data set, such as a plurality of features of a plurality of entities.

A decision retrieval module 120 may be configured to search the decision database 125 to retrieve decisions that are relevant to a particular section of an artifact. The decision retrieval module 120 may retrieve the decisions based on the segment 102 of the template 100 that is provided to the generative machine learning model 110. For instance, the name “parValue” chosen as the name for variable “parameterValue” in the example above may be a recorded decision. The recording may include the chosen name “parValue” and the name of the variable for which the name was chosen, “parameterValue.” Template segment 102B may contain the variable “parameterValue.” Decision retrieval module 120 may search segment 102B and identify the variable “parameterValue” within the segment 102B. Based on this identification, decision retrieval module 120 may retrieve the recorded decision that identifies “parValue” as the name chosen for “parameterValue” and provide this decision as input to generative model 110. Based on segment 102B and the decision 115A, artifact segment 135 may be generated. Artifact segment 135 may include decisions (e.g., decisions 115B) that are consistent with decisions made for previous segments (e.g., decisions 115A). For example, the name “parValue” may be used for the variable “parameterValue”in artifact segment 135, as well as previous segments.

The generative model 110 may be trained to process embeddings (e.g., embeddings of decisions and template segments) and perform token-based artifact generation based on the embeddings. For example, the generative model 110 may identify a variable within a software artifact template that is semantically similar to a variable included in a decision (e.g., based on using a semantic similarity algorithm). The generative model 110 may generate an artifact segment based on generating a name for the variable in the template that is similar (e.g., identical) to a name in the decision.

In certain embodiments, decision retrieval module 120 may be configured to search embedding representations of decisions. For example, decision retrieval module 120 may compare embedding representations of template segments 102 with embedding representations of decisions using a semantic similarity algorithm, such as cosine similarity or a nearest neighbor algorithm. Some embodiments provide that the decision retrieval module 120 comprises a machine learning model that is configured to compare embeddings to identify decisions that are relevant to the segment of the artifact. If the semantic similarity of a segment 102 and a decision exceeds a threshold, the decision may be provided to the generative model 110. For example, a recorded decision may consist of a chosen variable name “parValue.” The template segment 102B may contain the variable “parameterValue.” Embedding representations may be created of the segment 102B and the recorded decision. The embedding representation of the segment 102B may be compared to embedding representations of all of the decisions stored within decision database 120. The “parValue” decision may be identified based on the comparing (e.g., because “parValue” may be semantically similar to “parameterValue”). Based on this identification, the “parValue” decision may be provided as input to the generative model 110, which may use “parValue” for the variable “parameterValue” (e.g., the generative model 110 may use “parValue” instead of “parameterValue” whenever “parameterValue” appears in the template segment 102B). In some cases, decision retrieval module 120 limits its search of decision database 125 to decisions that are associated with the same artifact, artifact template, or artifact type as the artifact currently being generated. Some embodiments provide that the decisions are provided as part of a prompt explaining that the decisions are past decisions (e.g., decisions involving variable names) made by the generative model 110. When provided with the decisions and a segment of an artifact template as part of a prompt, the generative machine learning model 110 may generate an artifact segment 135 that contains decisions that are consistent with the decisions contained in the prompt.

In some embodiments, an artificial intelligence (AI) agent comprising a machine learning model may be configured to generate artifacts using one or more computing components described herein. The AI agent may receive a prompt from a user that indicates a type of artifact to create. Based on this prompt, the AI agent may orchestrate between a model that predicts sizes for template segments that may not exceed the capacity of the generative model 110, a module that selects template segments based on the predicted size, the decision retrieval module 120, and the generative model 130 to create the artifact. For example, the AI agent may invoke the segment selection module to retrieve a template corresponding to the artifact to be generated. The template may be provided to the size prediction model which may predict segment sizes based on the template. The AI agent may then use the predicted sizes to retrieve the segments of the template (e.g., by invoking the segment selection module). Decision retrieval module 120 may then be invoked to retrieve decisions that are relevant to a template segment. Generative model 110 may then be invoked and provided with the template segments and the decisions, such as along with a prompt instructing generative model 110 to generate a first or next segment of the artifact according to one or more particular parameters, such as specified in the prompt from the user (e.g., the prompt from the user may be provided as an input to generative model 110).

### Example of a Template Segment and Recorded Decisions Used to Automatically Generate Artifacts

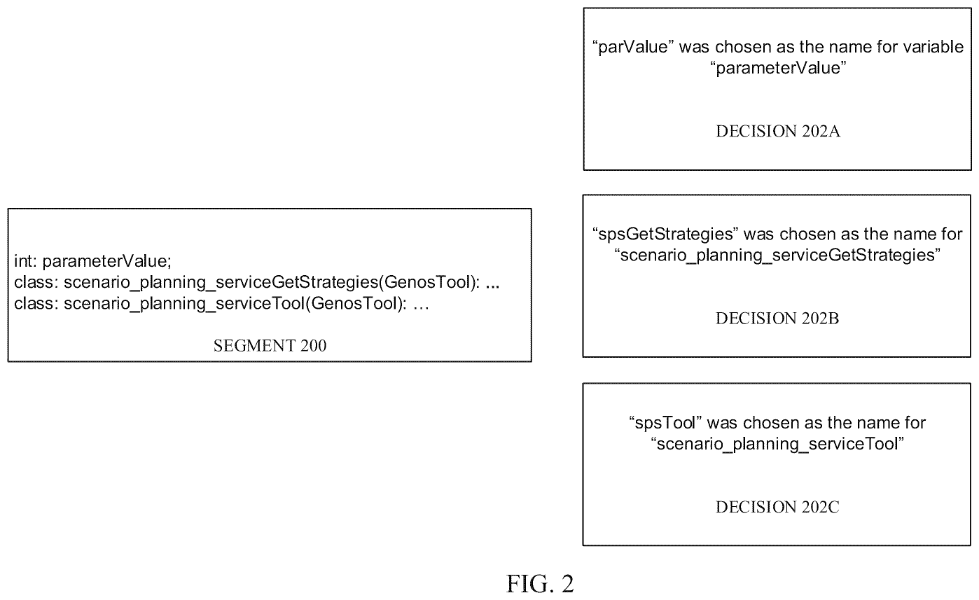

FIG. 2 depicts an example of a template segment and recorded decisions used to automatically generate artifacts.

As discussed above with respect to FIG. 1, a segment 200 of a template may be used to generate an artifact. For example, a generative machine learning model may generate a segment of the artifact based on the segment of the template. The template segment 200 shown in FIG. 2 corresponds to a software artifact template. For example, the software artifact template may be a generic version of the software artifact that a generative machine learning model will generate. A complete artifact may be created by concatenating the multiple generated artifact segments.

The segment 200 includes several name variables, including the parameter “parameterValue,” as well as the functions “scenario_planning_serviceGetStrategies” and “scenario_planning_serviceTool.”

Decisions 202A-C represent decisions that the generative machine learning model made regarding these name variables when generating a previous segment of the artifact. In this example, the previous segment included each of the name variables, and the generative machine learning model chose a name for each variable. The generative machine learning model chose the name “parValue” for the variable “parameterValue,” as indicated by decision 202A. Decision 202A may have been generated by the generative machine learning model. For example, the generative machine learning model may have been prompted to output and/or record all discretionary decisions it made regarding generation of an artifact. As shown in FIG. 2, the generated recording says “‘parValue’ was chosen as the name for variable ‘parameterValue.’” When provided with this decision 202A, the generative machine learning model may avoid generating a segment of artifact with a name that contradicts the chosen name (e.g., “parameterVal” or “parVal”).

Decisions 202B and 202C may have been generated by the generative machine learning model. Alternatively, decisions 202B and 202C may have been generated by a computing component other than the generative machine learning model. For example, a data parser may have been used to parse all of the variable names in the previous segments. As shown in FIG. 2, the generated recordings comprise “‘spsGetStrategies’ was chosen as the name for ‘scenario_planning_serviceGetStrategies’” for decision 202B and “‘spsTool’ was chosen as the name for ‘scenario_planning_serviceTool’” for decision 202C. When provided with these decisions 202B, 202C, the generative machine learning model may avoid generating a segment of artifact with a name that contradicts the chosen names (e.g., avoiding selecting contradicting names such as “spsGetStrat” or “Tool” which may have been selected using prior techniques). For example, the generative machine learning model may, based on semantic similarity (e.g., semantic similarity of embeddings), identify “spsGetStrategies” as referring to the same variable as “scenario_planning_serviceGetStrategies” in the template segment 200. Based on this identification, the generative machine learning model may use “spsGetStrategies” as the variable name for the function corresponding to the name “scenario_planning_serviceGetStrategies” in the template segment 200. In other words, the generative machine learning model may generate a segment of an artifact where “spsGetStrategies”is the name used for the function.

Decisions 202A-C may be retrieved based on semantic similarity searches involving embeddings of decisions and segments. For example, embedding representations of decisions, such as decisions 202A-C, may be created and stored in an embedding database. An embedding representation of a segment may be created, and decisions that are relevant to the segment may be retrieved based on comparing the semantic similarity of the decisions and the segment. If the similarity exceeds a threshold, a decision may be included with the input to the generative model (e.g., along with the segment). For example, decision 202B may be identified as relevant to the segment 200 because of the similarity of “spsGetStrategies” to “scenario_planning_serviceGetStrategies.” Such similarity may be identified based on using a semantic similarity algorithm (e.g., cosine similarity or Euclidean distance) to compare the embedding vectors.

It is noted that the use of vectors such as embeddings and techniques such as semantic similarity are included as examples, and decisions may be recorded and retrieved using other techniques. For example, decisions may be recorded based on associating components from a template (e.g., variables) with indications of decisions relating to those components (e.g., selected names for the variables), such as in association with an identifier of the template and/or artifact and/or artifact type, and may be retrieved based on such an identifier and/or based on a character search or other retrieval technique. Furthermore, in some embodiments, decisions associated with generating a particular segment of an artifact may be stored in memory as each segment is generated and/or directly provided to the generative machine learning model after a given segment is generated in connection with prompting the generative machine learning model to generate a next segment (e.g., with or without storing such decisions in a database or other more permanent data structure).

### Example Operations Related to Automatically Generating Artifacts

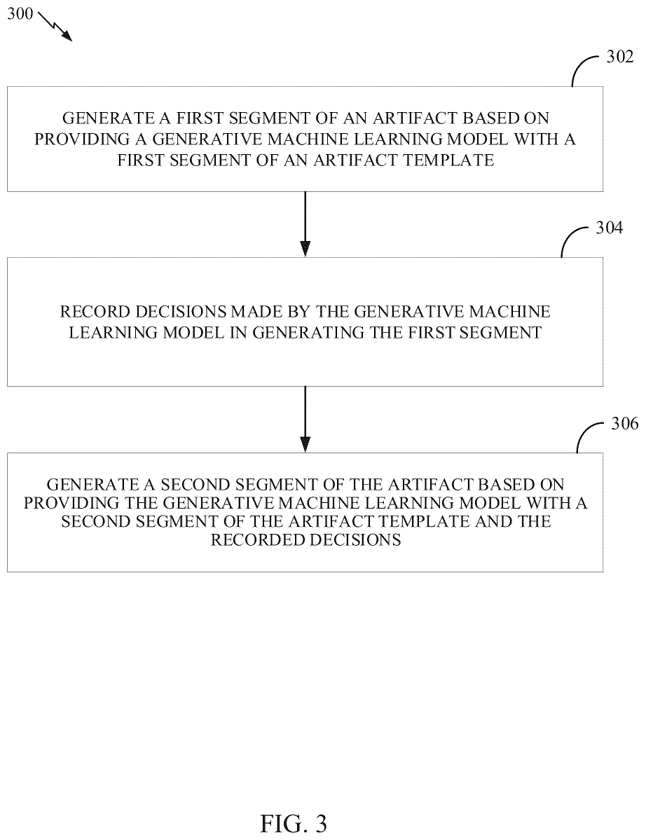

FIG. 3 depicts example operations 300 related to automatically generating artifacts. For example, operations 300 may be performed by one or more of the components described with respect to FIG. 1 or FIG. 2.

Operations 300 begin at step 302 with generating a first segment of an artifact based on providing a generative machine learning model with a first segment of an artifact template. In some embodiments the artifact comprise a software artifact.

Operations 300 continue at step 304 with recording decisions made by the generative machine learning model in generating the first segment. Certain embodiments provide that the decisions comprise selecting a name for a corresponding variable within the software artifact. In some embodiments, the recording comprises listing the name as a chosen name for a variable associated with a software artifact template. According to certain embodiments, the artifact comprises an image and a decision of the decisions comprises a choice involving a color palette of the image.

Operations 300 continue at step 306 with generating a second segment of the artifact based on providing the generative machine learning model with a second segment of the artifact template and the recorded decisions. Some embodiments provide that the generating is based on providing a prompt to the generative machine learning model and the prompt includes a recorded decision of the recorded decisions.

Some embodiments provide that relevant recorded decisions are retrieved based on a given segment of the artifact template and a given segment of the artifact is generated based on the retrieved relevant recorded decisions and the given segment of the artifact template. In certain embodiments, the recording comprises creating embedding representations of the decisions and the retrieving is based on a semantic similarity comparison involving the embedding representations and the second segment of the artifact template. In some embodiments, an embedding database is created based on the embedding representations and the semantic similarity comparison involves an additional machine learning model that is trained to search the embedding database based on a given artifact template.

Certain embodiments provide that a complete artifact is generated based on concatenating the first segment and the second segment of the artifact.

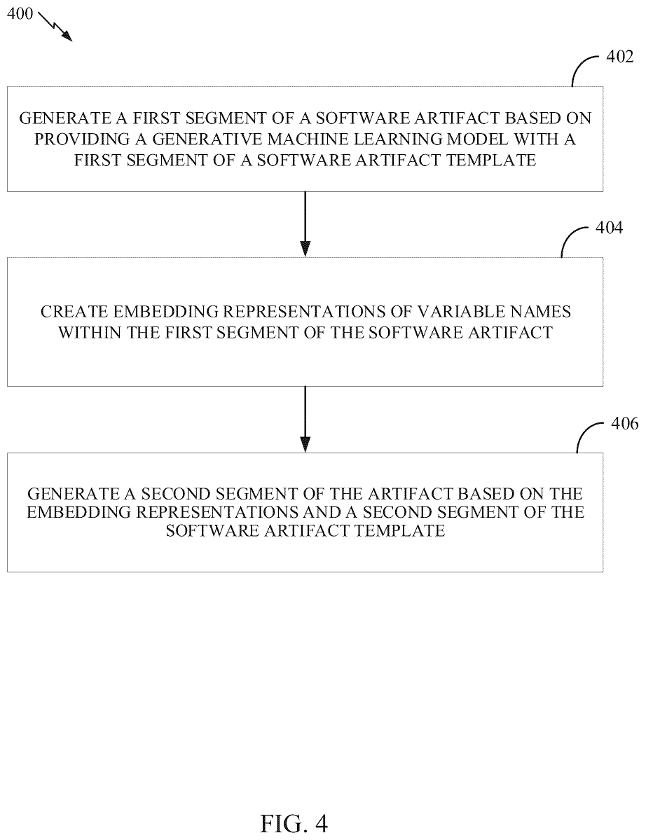

FIG. 4 depicts additional example operations 400 related to automatically generating artifacts. For example, operations 400 may be performed by one or more of the components described with respect to FIG. 1.

Operations 400 begin at step 402 with generating a first segment of a software artifact based on providing a generative machine learning model with a first segment of a software artifact template.

Operations 400 continue at step 404 with creating embedding representations of variable names within the first segment of the software artifact.

Operations 400 continue at step 406 with generating a second segment of the artifact based on the embedding representations and a second segment of the software artifact template.

### Example of a Processing System for Automatically Generating Artifacts

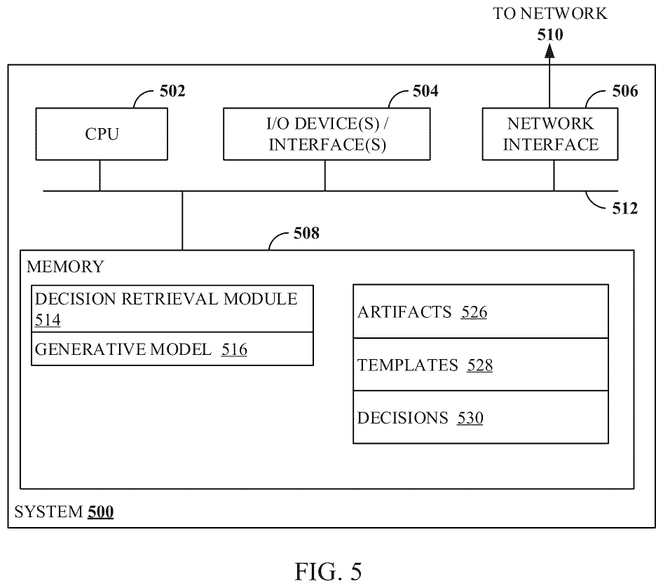

FIG. 5 illustrates an example system 500 with which embodiments of the present disclosure may be implemented. For example, system 500 may be configured to perform operations 300 of FIG. 3, operations 400 of FIG. 4, and/or to implement one or more components as in FIG. 1.

System 500 includes a central processing unit (CPU) 502, one or more I/O device interfaces that may allow for the connection of various I/O devices 504 (e.g., keyboards, displays, mouse devices, pen input, etc.) to the system 500, network interface 506, a memory 508, and an interconnect 512. It is contemplated that one or more components of system 500 may be located remotely and accessed via a network 510. It is further contemplated that one or more components of system 500 may comprise physical components or virtualized components.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, and memory 508. CPU 502 is included to be representative of a single CPU, multiple CPUs, a single CPU having multiple processing cores, and other arrangements.

Additionally, the memory 508 is included to be representative of a random access memory or the like. In some embodiments, memory 508 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 508 includes decision retrieval module 514 and generative model 516. Decision retrieval module 514 may be representative of decision retrieval module 120 of FIG. 1. Generative model 516 may be representative of generative model 110 of FIG. 1.

Memory 508 further comprises artifacts 526 which may correspond to one or more artifact segments 135 of FIG. 1. Memory 508 further comprises templates 528, which may include template 100 of FIG. 1 or a template containing segment 200 of FIG. 2. Memory 508 further comprises decisions, which may correspond to decisions 115A-B of FIG. 1 or decisions 202A-C of FIG. 2.

It is noted that in some embodiments, system 500 may interact with one or more external components, such as via network 510, in order to retrieve data and/or perform operations.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of generating artifacts, comprising:
generating a first segment of an artifact based on providing a generative machine learning model with a first segment of an artifact template;
recording decisions made by the generative machine learning model in generating the first segment; and
generating a second segment of the artifact based on providing the generative machine learning model with a second segment of the artifact template and the recorded decisions.

2. The method of claim 1, further comprising retrieving relevant recorded decisions based on a given segment of the artifact template, wherein a given segment of the artifact is generated based on the retrieved relevant recorded decisions and the given segment of the artifact template.

3. The method of claim 2, wherein the recording comprises creating embedding representations of the decisions, wherein the retrieving is based on a semantic similarity comparison involving the embedding representations and the second segment of the artifact template.

4. The method of claim 3, further comprising creating an embedding database based on the embedding representations, wherein the semantic similarity comparison involves an additional machine learning model that is trained to search the embedding database based on a given artifact template.

5. The method of claim 1, wherein the artifact comprise a software artifact.

6. The method of claim 5, wherein the decisions comprise selecting a name for a variable within the software artifact.

7. The method of claim 6, wherein the recording comprises listing the name as a chosen name for a corresponding variable associated with the software artifact template.

8. The method of claim 1, wherein the artifact comprises an image, and wherein a decision of the decisions comprises a choice involving a color palette of the image.

9. The method of claim 1, wherein the generating is based on providing a prompt to the generative machine learning model, wherein the prompt includes a recorded decision of the recorded decisions.

10. The method of claim 1, further comprising generating a complete artifact based on concatenating the first segment and the second segment of the artifact.

11. A system for generating artifacts, comprising:
one or more processors; and
a memory comprising instructions that, when executed by the one or more processors, cause the system to:
generate a first segment of an artifact based on providing a generative machine learning model with a first segment of an artifact template;
record decisions made by the generative machine learning model in generating the first segment; and
generate a second segment of the artifact based on providing the generative machine learning model with a second segment of the artifact template and the recorded decisions.

12. The system of claim 11, wherein the instructions further cause the system to retrieve relevant recorded decisions based on a given segment of the artifact template, wherein a given segment of the artifact is generated based on the retrieved relevant recorded decisions and the given segment of the artifact template.

13. The system of claim 12, wherein the recording comprises creating embedding representations of the decisions, wherein the retrieving is based on a semantic similarity comparison involving the embedding representations and the second segment of the artifact template.

14. The system of claim 13, further comprising an embedding database that is created based on the embedding representations, wherein the semantic similarity comparison involves an additional machine learning model that is trained to search the embedding database based on a given artifact template.

15. The system of claim 11, wherein the artifact comprise a software artifact.

16. The system of claim 15, wherein the decisions comprise selecting a name for a variable within the software artifact.

17. The system of claim 16, wherein the recording comprises listing the name as a chosen name for a corresponding variable associated with the software artifact template.

18. The system of claim 1, wherein the generating is based on providing a prompt to the generative machine learning model, wherein the prompt includes a recorded decision of the recorded decisions.

19. The system of claim 1, wherein the instructions further cause the system to generate a complete artifact based on concatenating the first segment and the second of the artifact.

20. A method of generating software artifacts, comprising:
generating a first segment of a software artifact based on providing a generative machine learning model with a first segment of a software artifact template;
creating embedding representations of variable names within the first segment of the software artifact; and
generating a second segment of the artifact based on the embedding representations and a second segment of the software artifact template.
